(19) United States
(12) Patent Application Publication
(10) Pub. No.: US 2003/0000015 A1
(43) Pub. Date: Jan. 2, 2003

(54) Sick-bed

(76) Inventor: Albrecht Horlin, Erlenbach (DE)

Correspondence Address: BURNS DOANE SWECKER & MATHIS L L P, POST OFFICE BOX 1404, ALEXANDRIA, VA, 22313-1404, US

(21) Appl. No.: 10/169,674

(22) PCT Filed: Dec. 22, 2000
(86) PCT No.: PCT/EP00/13262

(30) Foreign Application Priority Data
Jan. 11, 2000 (DE) 100 01 687.1

(51) Int. Cl. A61G 7/00; A47C 21/00

(52) U.S. Cl. 5/600; 5/610

(57) ABSTRACT

The sick-bed is comprised of a bedstead and a bed frame as the mattress support, mounted cardanically on same for the decubitus prophylaxis, which bed frame can be precessed by means of a drive unit. The bed frame is cardanically suspended on at least three, in particular four lifting drives, which are separate from each other and continuously height-adjustable. Said lifting drives are controllable in such a manner that the central normal of the bed frame running through the gravity center of the bed frame is allowed to carry out a continuous, damped and slow precession movement.

### DESCRIPTION

The invention relates to a sick-bed, wherein, for the decubitus prophylaxis, a dimensionally stable bed frame as the mattress support, is cardan-mounted on a bedstead, and can be precessed by means of a drive unit.

A sick-bed of this kind is known from European Patent Specification EP 799 010 B1. This sick-bed mounts the bed frame centrally on the bedstead in the gravity center of the bed frame by means of an axial ball bearing, the bearing shells of which receive the roller bodies, being precessable relative to each other. This is effected by a wedge disk arranged between the bearing shells and mechanically actuated through a pinion gear.

For achieving an optimum decubitus prophylaxis, a precession frequency in the range of between 6 and 36°/min, at a maximum amplitude in the range of between 3 and 10 cm relative to the maximum excursion from the horizontal of a patient laid on the bed, has proved successful.

While the decubitus prophylaxis with the known bed leads to extremely satisfying results, the bearing application and the conception of the precession drive of the bed frame on the bedstead have turned out to be problematic. Problems arose, for one, in the nursing sector, where many manipulations and aid to be stored temporarily require a sufficiently free space below the gravity center zone of the bedstead, and for another, are due to the scope of mechanical experiences with said known drive. Thus, said known drive is relatively expensive and heavy, necessitates a comparably complex installation, and requires, and this in turn also with respect to the nursing situation, an arrangement of the mechanical drive directly on the sick-bed. This is often regarded as being disturbing, and namely even then when the drive is not fixed on the bed frame but on the bedstead.

Starting from this prior art, the invention is based on the technical problem of further developing the known medical sick-bed for the decubitus prophylaxis in such a manner that the bed center remains unobstructed, that the precession drive is allowed to be configured noiseless, and namely also noiseless over the long term, and is allowed to be configured of a mechanically higher resistance than the strongly loaded bearing shells and the bearing drive known from prior art.

The invention solves this problem by means of a sick-bed, the bed frame of which is not mounted on roller bearings but on at least three lifting drives height-adjustable in a continuous and arbitrarily reversible manner, the operation thereof being arranged coordinate in such a way that the initially mentioned precession data are allowed to be set without problems and, above all, without noise. With this configuration of the bearing and the precession drive, a change of the precession frequency, as well as of the precession amplitude can in particular be achieved in a considerably simpler manner than it is possible with the mechanical roller bearing according to the prior art. According to the invention, it is moreover possible to mount the bed frame height-adjustable and inclination-adjustable with respect to its stationary position.

Preferably, four continuously height-adjustable lifting drives vertically fixed to the bedstead are used, each carrying the bed frame in the zone of its four corners. This articulation to the bed frame is thereby configured cardanically, for example by means of a ball-and-socket joint or a cardan joint.

For achieving a highest possible mobility of the sick bed intended for the decubitus prophylaxis, the continuously height-adjustable lifting drives according to an embodiment of the invention, are configured as an electromotively adjustable telescopic lifting column.

For creating the desired position of the bed frame, e.g. for the simple static height adjustment or the inclination angle adjustment or even for the dynamically oscillating or precessional motion, threaded spindles are provided for each telescopic lifting column.

The number and height of the telescoping spindles thereby corresponds to the amount of the maximally required height adjustment or, with respect to the mobility of the bed, to the amount of the maximally required amplitude.

The telescopic lifting column is realized in such a manner that within a cylindrical outer sleeve, a working rod is disposed, within which, for example, two threaded spindles with the corresponding spindle nuts are provided intended for a two-fold height adjustment of the lifting columns.

The height adjustment itself ensues by coupling said spindles to an electronically driven electric motor via a gear, for example a planetary gear, and via corresponding toothed wheels. In particular, each lifting spindle is thereby assigned an electric motor of its own.

For the height adjustment furthermore, either the electric motor is configured as a reversing motor or the gear is configured as a reversing gear. Thereby, the drive unit for the telescopic lifting column is in particular conceived in such a manner that it allows for a mobile energy supply. Moreover, said drive unit should feature dimensions as small as possible relative to the size of the telescopic lifting column itself.

With respect to the use in a sick-room, moreover, only electric motors as silent as possible should be used as drive units. Also, a particularly effective acoustic decoupling, at least a sound absorption has in addition to be provided for, preventing a transmission of structure-borne noise from the drive unit into the bedstead and the bed frame, as well as an emission of airborne noise from the drive unit into the sick-room.

The working rod of the telescopic lifting column, which rod is guided within the cylindrical sleeve, comprises on its end an articulation ball head forming a cardan ball-and-socket joint with a corresponding ball socket of the bed frame, or is articulated to the bed frame via a cardan universal joint. In these bearing locations, the means for the absorption of the structure-borne noise or for the decoupling of the structure-borne noise are in particular arranged.

If the telescopic lifting column is supposed to create movements with a high precession frequency and maximum amplitude, then the cardanic suspension has to be realized preferably via universal joints.

According to a second embodiment of the invention, the height-adjustable lifting drives are configured as a hydraulically integrated constructional unit with a hydraulic working cylinder, and namely preferably so that each of the working cylinders is equipped with a pump of its own and with a central control valve of its own having a closed hydraulic circuit. The hydraulic compressors used thereby are preferably acted upon electrically and are controlled electronically. With the use and installation of an electric energy storage in the bedstead, such a prophylaxis bed is mobile even for a longer period of time and can be used independent of an external supply.

If, however, an absolute silence of the precession drive has to be set, and the capacity of a mobile displacement of the prophylaxis bed is of secondary importance, then the hydraulic working cylinders are configured without an integrated compressor and without an integrated valve. Instead, all hydraulic working cylinders are connected to a central hydraulic multiple valve which can be controlled in a programmed manner, which multiple valve is connected to a common external pressure supply, for example, to a hydraulic compressor standing isolated in the next room, or to an already existing central hydraulic pressure supply line. The hydraulic working cylinders themselves, which cause the precession of the bed frame, work without any noise development, and thereby work continuously and vibrationless to the highest degree.

In the following, the invention is explained in more detail by means of an exemplary embodiment in conjunction with the drawing. Thereby, the single Figure, namely

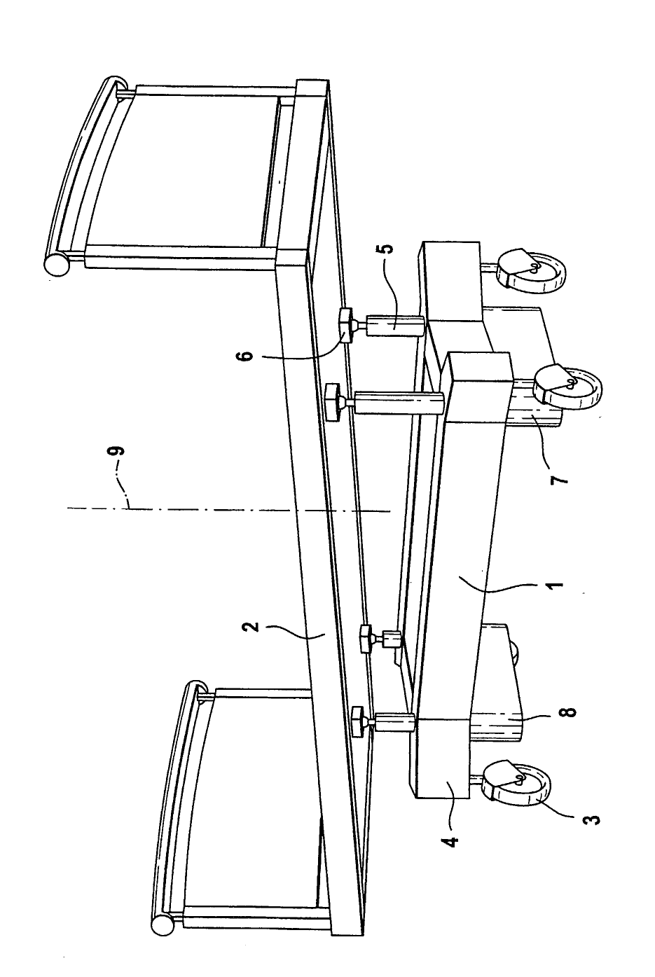

FIG. 1 shows in a schematic perspective representation, a sick-bed exhibiting the features of the invention.

### The sick-bed shown in FIG. 1 is comprised of a bedstead 1 and a rigid and dimensionally stable bed frame 2.

The bedstead 1 is configured substantially rectangular, and is so dimensioned that it remains just slightly within the outer dimensions of bed frame 2. By means of four wheels 3 articulated to cantilevers 4 of bedstead 1, the sick-bed is designed to be movable.

In the zone of the four outer corners of bedstead 1, continuously height-adjustable telescopic lifting columns 5 are fixed in each case. All of the four telescopic lifting columns are realized identical. Each of the height-adjustable columns 5 is vertically fixed to the bed frame in a rigid and stationary manner, hence, for example, welded or screwed with same. On the head of each working rod of each telescopic lifting column 5, an articulation ball head is realized forming a cardanic ball-and-socket joint with a corresponding ball socket of bed frame 2.

In a way not shown here in the Figure, the cardanic joint 6, which can likewise be configured as a universal joint, is realized releasable on the head of the working rod of the telescopic lifting column 5, so that the bed frame is mobile after an adjusting manipulation even without the bedstead and its lifting drives, so that it can be transferred, for example during emergency cases, onto a secondary undercarriage.

The adjustable lifting column 5 is comprised of a number of telescoping spindles, which are movable through a motor and a corresponding gear, either the motor being configured as a reversing motor or, alternatively, the gear being configured as a reversing gear.

For the operation of the telescoping spindles, only the driving current for the motor and the voltage for the electronic signal unit are still required. Thereby, these elements could be designed so far miniaturized, due to the little power necessary, that in the way outlined in FIG. 1, an electric storage 7 and an electronic processor 8 are integrated in the bedstead 1 for all four of the telescopic columns in common.

The sick-bed for the decubitus prophylaxis described here, is characterized by an immediately responding spindle drive and a simple mobile energy supply, whereby a large number of accessories can be dispensed with, which in turn signifies a weight saving.

In operation, the telescopic lifting columns are controllable in such a manner that the central normal 9 of the bed frame running through the gravity center of the bed frame 2, carries out a continuous and slow precession movement without perceptible increments.

1. A sick-bed comprised of a bedstead and, for the decubitus prophylaxis, a bed frame as the mattress support, mounted cardanically on said bedstead, which bed frame per se is dimensionally rigid and can be precessed by a drive unit, characterized by
a mounting of the bed frame (2) on at least three continuously height-adjustable lifting drives (5) which are separate from each other.

2. The sick-bed according to claim 1, characterized by
a mounting of the bed frame (2) on four lifting drives (5), one of each being in each case articulated to one of the four corners each of a rectangular bed frame (2) in each case via a cardan joint (6).

3. The sick-bed according to any one of claims 1 or 2, characterized by
a vertical fixation of the lifting drives (5) on the bedstead (1).

4. The sick-bed according to any one of claims 1 through 3, characterized by
a group drivability of the lifting drives (5) in such a manner that the bed frame (2) optionally is mounted continuously precessable or is stationarily height-adjustable or inclination-adjustable.

5. The sick-bed according to any one of claims 1 through 4, characterized by
a lifting drive (5) which can be acted upon electromotively.

6. The sick-bed according to claim 5, characterized by
an electromotively settable telescopic lifting column as the lifting drive (5).

7. The sick-bed according to any one of claims 1 through 4, characterized by
a hydraulic working cylinder as the lifting drive (5).

8. The sick-bed according to claim 7, characterized by
a configuration of the hydraulic working cylinders (5) as an in each case integrated constructional unit having a compressor and a control valve.

9. The sick-bed according to any one of claims 7 or 8, characterized by
compressors of the working cylinders (5), which compressors are electronically drivable and which can be electrically acted upon.

10. The sick-bed according to any one of claims 7 through 9, characterized by
a central hydraulic multiple valve for the selective setting of the hydraulic working cylinders (5), and a connection of said multiple valve to a central compressor or a central hydraulic pressure supply line.

11. The sick-bed according to any one of claims 1 through 10, characterized by
a bed frame (2), which, independent of the bedstead (1), can be transferred onto a secondary undercarriage.
